(19) United States
(12) Patent Application Publication
(10) Pub. No.: US 2025/0096895 A1
(43) Pub. Date: Mar. 20, 2025

(54) COMMISSIONING A DEVICE BASED ON VISIBLE LIGHT SIGNALS RECEIVED BY MULTIPLE DEVICES

(71) Applicant: SIGNIFY HOLDING B.V., EINDHOVEN (NL)

(72) Inventors: MARCO PIERONI, EINDHOVEN (NL); ETIENNE MARIE BERTOU, VELDHOVEN (NL)

(21) Appl. No.: 18/726,552

(22) PCT Filed: Dec. 16, 2022
(86) PCT No.: PCT/EP2022/086292

§ 371 Date: Jul. 3, 2024

(30) Foreign Application Priority Data
Jan. 3, 2022 (EP) 22150019.2

(51) Int. Cl. H04B 10/116

(52) U.S. Cl. CPC H04B 10/116

(57) ABSTRACT

A mobile device (1) for commissioning a commissionable device (31) into a system is configured to receive (73), via an optical sensor, one or more visible light signals transmitted by the commissionable device and receive (79), via a radio frequency receiver, one or more radio frequency signals. The one or more visible light signals comprise data and the one or more radio frequency signals comprise further data which has been determined based on the one or more visible light signals transmitted by the commissionable device as received (74) by a further optical sensor of a sensor device (11). The mobile device is further configured to perform a process of commissioning (81-83) the commissionable device into the system based on the data and the further data.

### FIELD OF THE INVENTION

The invention relates to a mobile device for commissioning a commissionable device into a system.

The invention further relates to a method of commissioning a commissionable device into a system.

The invention also relates to a computer program product enabling a computer system to perform such a method.

### BACKGROUND OF THE INVENTION

After lighting devices have been physically installed, they normally need to be commissioned into a lighting system first before they can be used. For example, an alphanumeric commissioning code may be printed on each lighting device and these codes may then be input in a software application to start a targeted discovery. Sometimes, lighting devices that are not factory-new need to be (re-)commissioned into a lighting system. In this case, an installer would need to reach and remove, e.g. unscrew, a lighting device, write down the alphanumeric commissioning code and replace, e.g. screw back, the lighting device, and do this for each lighting device, e.g. light bulb.

Luckily, easier ways of commissioning lighting devices into a lighting system have been developed. For example, US 2017/041886 A1 discloses the use of a mobile computing device e.g. a smart phone, to discover control devices, e.g. lighting devices, upon receipt of control device beacons transmitted from the control device. These beacons may include a serial number that corresponds to the control device, a link address for communicating with the control device, or another unique identifier. The beacons may be transmitted via RF communication signals. A list of the discovered control devices may be displayed in an ascending or descending order according to the signal strength at which the corresponding control device beacon is discovered. The user may then associate the discovered control devices with groups, e.g. rooms. Information, e.g. link addresses, may also be transmitted using visible light signals.

However, a drawback of using RF signals is that RF signals pass through walls and make it more difficult to determine which room a lighting device is located in and a drawback of using the users' own mobile computing devices to decode visible light signals is that the decoding success rate depends on the hardware of and software stack running on the users' mobile computing devices.

### SUMMARY OF THE INVENTION

It is a first object of the invention to provide a mobile device, which can be used to reliably perform a process of commissioning a commissionable device which transmits visible light signals to facilitate the commissioning.

It is a second object of the invention to provide a method, which can be used to reliably perform a process of commissioning a commissionable device which transmits visible light signals to facilitate the commissioning.

In a first aspect of the invention, a mobile device for commissioning a commissionable device into a system comprises at least one optical sensor, at least one radio frequency receiver, and at least one processor configured to receive, via said at least one optical sensor, one or more visible light signals transmitted by said commissionable device, said one or more visible light signals comprising data, receive one or more radio frequency signals via said at least one radio frequency receiver, said one or more radio frequency signals comprising further data, said further data being determined based on said one or more visible light signals transmitted by said commissionable device as received by at least one further optical sensor of a sensor device, said sensor device and said mobile device being different devices, and perform a process of commissioning said commissionable device into said system based on said data and said further data.

By using a separate sensor device, the characteristics of the hardware can easily be taken into account and the algorithms can be better tailored to have a reliable experience for all users. This sensor device is normally already commissioned into the system. However, by letting the mobile device directly use data from the visible light signals transmitted by the commissionable device in addition to the further data determined based on the visible light signals as received by the sensor device, the commissioning process can be made easier for the user. Optionally, data comprised in radio frequency signals transmitted by the commissionable device may additionally be used, if present. Said commissionable device may be a lighting device and said system may be a lighting system, for example. The radio frequency signals may be received directly from the sensor device itself or from a controller of the system (e.g. a bridge), for example.

Said at least one processor may be configured to provide a user interface to guide a user in said process of commissioning said commissionable device into said system based on said data. This is a first manner of making the commissioning process easier for the user. Said data may be indicative of a status of said process of commissioning said commissionable device according to said commissionable device, for example.

Said at least one processor may be configured to inform said user of said status. By informing the user of the status of the commissioning process as experienced by the commissionable device, it becomes easier for the user to determine why the commissioning process is not proceeding as expected. This status would normally not be included in the further data. Said at least one processor may be configured to determine instructions based on said status and provide said instructions to said user via said user interface. For example, if the user believes he has put the commissionable device in a light pattern transmission mode, but the status indicates otherwise, the instructions could instruct the user how to (correctly) put the commissionable device in the light pattern transmission mode.

Said further data may be indicative of a further status of said process of commissioning said commissionable device according to a controller of said system and said at least one processor may be configured to determine whether a difference exists between said status and said further status and inform said user of said difference if said difference is determined to exist. For example, a lamp might indicate that it is not receiving a key to join the (e.g. Zigbee) network while the bridge indicates that this key has been sent.

Said at least one processor may be configured to determine instructions based on said difference and provide said instructions to said user via said user interface. For example, the instructions might provide one or more solutions that the user could try to solve the problem of the lamp not receiving the network key. Said at least one processor may be configured to inform said user of said further status if no difference is determined to exist between said status and said further status.

Said further data may be indicative of a first spatial area associated with said sensor device and said at least one processor may be configured to determine a second spatial area in which said mobile device is located, determine a spatial area of said commissionable device based on said first and second spatial areas, and commission said commissionable device into said system with said spatial area. This is a second manner of making the commissioning process easier for the user. If a sensor device can receive light from devices in multiple groups, e.g. lighting devices in an open kitchen and lighting devices in an adjoining living room, the spatial location of the mobile device may be used to determine the spatial location of the commissionable device more precisely.

Said at least one processor may be configured to determine whether said first spatial area and said second spatial area correspond to a same spatial area and associate said same spatial area with said commissionable device as part of said commissioning process if said first spatial area and said second spatial area determined to correspond to said same spatial area. If the first and second spatial areas correspond to the same spatial area, e.g. same room, then this may be assumed to be the spatial area in which the commissionable device is located. If the first and second spatial areas do not correspond to the same spatial area, the user may be offered the possibility to restart the transmission and detection of the visible light signals, e.g. after changing the position of the mobile device and/or the sensor device, and/or may be offered the possibility to manually indicate a spatial area.

Said at least one processor may be configured to receive, via said at least one optical sensor, one or more further visible light signals transmitted by a second commissionable device, said one or more further visible light signals comprising second data, determine whether said further data are based on said one or more further visible light signals transmitted by said second commissionable device, determine a further spatial area of said second commissionable device based on said second spatial area if said further data are not based on said one or more further visible light signals transmitted by said second commissionable device, and perform a process of commissioning said second commissionable device into said system based on said second data. If there is not a sensor device in each room, an indication that no sensor device received the visible light signals from a commissionable device may still be used beneficially. In that case, the spatial location of the mobile device may be used as spatial location of this commissionable device.

In a second aspect of the invention, a lighting system comprising said mobile device and further comprises said sensor device and/or said commissionable device.

In a third aspect of the invention, a method of commissioning a commissionable device into a system comprises receiving, via at least one optical sensor, one or more visible light signals transmitted by said commissionable device, said one or more visible light signals comprising data, receiving one or more radio frequency signals via at least one radio frequency receiver, said one or more radio frequency signals comprising further data, said further data being determined based on said one or more visible light signals transmitted by said commissionable device as received by at least one further optical sensor of a sensor device, said sensor device and said mobile device being different devices, and performing a process of commissioning said commissionable device into said system based on said data and said further data. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for commissioning a commissionable device into a system.

The executable operations comprise receiving, via at least one optical sensor, one or more visible light signals transmitted by said commissionable device, said one or more visible light signals comprising data, receiving one or more radio frequency signals via at least one radio frequency receiver, said one or more radio frequency signals comprising further data, said further data being determined based on said one or more visible light signals transmitted by said commissionable device as received by at least one further optical sensor of a sensor device, said sensor device and said mobile device being different devices, and performing a process of commissioning said commissionable device into said system based on said data and said further data.

As will be appreciated by one skilled in the art, aspects of the present invention may be embodied as a device, a method or a computer program product.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the mobile device;

FIG. 2 shows an example flow of the commissioning process;

FIG. 3 is a flow diagram of a first embodiment of the method;

FIG. 4 is a flow diagram of a second embodiment of the method;

FIG. 5 is a flow diagram of a third embodiment of the method;

FIG. 6 is a flow diagram of a fourth embodiment of the method;

FIG. 7 is a flow diagram of a fifth embodiment of the method; and

FIG. 8 is a block diagram of an exemplary data processing system for performing the method of the invention.

Corresponding elements in the drawings are denoted by the same reference numeral.

### DETAILED DESCRIPTION OF THE EMBODIMENTS

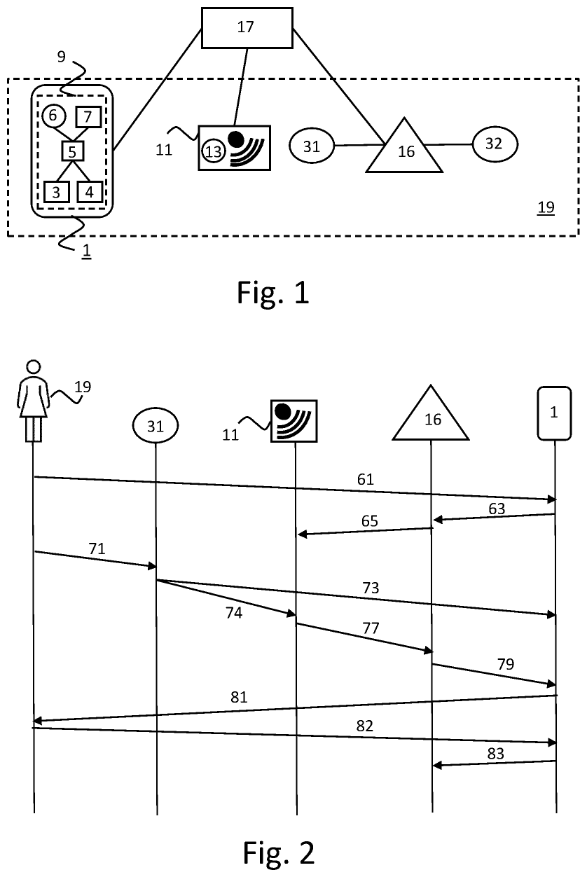

FIG. 1 shows an embodiment of a mobile device for commissioning a commissionable device into a system. A lighting system 19 comprises a mobile device 1, a sensor device 11, a bridge 16 (i.e. a controller of the system), and two commissionable lighting devices 31 and 32. Lighting devices 31 and 32 may be Philips Hue lamps, for example. The bridge 16 may be a Philips Hue bridge, for example. The mobile device 1, the sensor device 11, and the bridge 16 are connected to a wireless LAN access point 17, e.g., via Wi-Fi or Ethernet.

The mobile device 1 comprises an RF receiver 3, an RF transmitter 4, a processor 5, an optical sensor 6, memory 7, and a touchscreen display 9. The processor 5 is configured to receive, via the optical sensor 6, one or more visible light signals transmitted by commissionable lighting device 31 and receive one or more radio frequency signals via RF receiver 3, e.g. from the bridge 16 or from the sensor device 11 via the wireless LAN access point 17.

The one or more visible light signals comprise data. The one or more radio frequency signals comprise further data. The further data have been determined based on the one or more visible light signals transmitted by the commissionable lighting device 31 as received by optical sensor 13 of sensor device 11. The further data may be determined by the bridge 16 based on data transmitted to it by the sensor device 11 or by the sensor device 11 itself, for example.

The processor 5 is further configured to perform a process of commissioning the commissionable lighting device 31 into the lighting system 19 based on the data and the further data. The mobile device 1 and the sensor device 11 have already been commissioned into the lighting system 19 when the lighting device 31 is commissioned. The sensor device 11 may additionally be used for sensing motion and/or for measuring (environment) light levels.

After the lighting device 31 has been commissioned into the lighting system 19, the mobile device 1 may be used to control the lighting device 31 via the bridge 16. The bridge 16 and the lighting device 31 may communicate via Zigbee, for example.

The role of the mobile device 1 in the commissioning process is illustrated with the help of FIG. 2. The example flow shown in FIG. 2 starts with interaction between a user 19 and mobile device 1 in step 61. In step 61, user 19 uses a software application on mobile device 1 to place one or more sensor devices in a light pattern detection mode waiting to pick-up visible light communication signals. The user 19 may be able to use the software application to select the closest sensor that can detect lighting device 31. If no sensor device is close by, the user can temporarily move one closer. Alternatively, all sensor devices may be placed in the light pattern detection mode.

Optionally, in step 61, the user 16 may select to which room or group the lighting device 31 needs to be assigned as part of the commissioning process and once confirmed, the already commissioned lighting devices of that room or group will be dimmed down. Furthermore, the software application may instruct the user 19 how to put a lighting device in light pattern transmission mode. FIG. 2 shows mobile device 1 transmitting a message to the bridge 16 to place one or more sensor devices in the light pattern detection mode in step 63. The bridge 16 then transmits a corresponding message to sensor device 11 in step 65.

Next, the user 19 puts lighting device 31 in the light pattern transmission mode, e.g. a “Serial Number Beaconing” (SNB) mode, in step 71. For example, the user may interact with the lighting device 31 by toggling it on/off the number of times instructed by the software application (e.g. five times). In the SNB mode, the lighting device 31 start beaming its serial number using visible light communication technology for e.g. 45 seconds, delimiting its payload via a predefined preamble.

When a lighting device, e.g. a lightbulb, is put in SNB mode, the light is set to a predefined brightness level. The information is then encoded with fixed-time light fluctuations, where each negative fluctuation can be interpreted as a low level while the nominal brightness will be interpreted as a high level. If the serial number format is XXXXXX where X is alphanumeric character encodable within 7 bit, the serial number will be encoded with 42 brightness level transitions. The information will be encoded in a loop; a preamble will be transmitted between each transmission. This preamble may be e.g. the 21 bit sequence 1011101 0001000 1011101, which represents characters not allowed in the serial number and thus easily recognizable.

For example, if the serial number is “AB1234CD”, this may be encoded as “1000001 1000010 0110001 0110010 0110011 0110100 1000011 1000100” and transmitted (repeated in a loop) as “1011101 0001000 1011101 1000001 1000010 0110001 0110010 0110011 0110100 1000011 1000100 . . . ”.

In order to improve the detection of the light fluctuations used to encode the serial number, the SNB mode may include a dynamic delta which may e.g. be increased every two repetitions. This will achieve a more prominent effect which will make it simpler for the optical sensor to pick up the light fluctuations under unfavorable conditions. Instead of the SNB mode, a different light pattern transmission mode may be used.

The visible light signals are received by the mobile device 1 in step 73 and by the sensor device 11 in step 74. Once the sensor device 11 detects the beaconing preamble, it decodes the serial number and transmits a packet in step 77, e.g. on the Zigbee network, indicating that the lighting device 31 has been detected. The bridge 16 receives this information, alters its own state accordingly, and generates an event for the software application running on the mobile device 1 in step 79. Optionally, the longer it takes to detect the lighting device 31, the lower the already commissioned lighting devices in the room or group are dimmed down, in order to simplify detection.

Once the software application running on mobile device 1 has been notified of the event, the process of commissioning lighting device 31 continues in step 81. Based on the data received in the visible light signals and the further data received from the bridge 16, the mobile device 1 provides information to the user in step 81. For example, when sensor device 11 is located in the hallway and lighting device 31 is detected by sensor device 11 when in light pattern transmission mode, it can be inferred that lighting device 31 needs to be commissioned to the hallway room/group in the lighting system.

Now, if lighting device 31 reports to the mobile device 1 that it is not receiving a key to join the network while the bridge 16 indicates to the mobile device 1 that this key has been transmitted to lighting device 31, the software application may provide instructions to the user 19 on how to solve this issue. After the user 19 has confirmed in step 82 that the user 19 indeed wants to commission lighting device 31 to the hallway room/group and the lighting device 31 has received the key, the mobile device 1 instructs the bridge 16 to make this association/pairing and complete the commissioning process in step 83.

Alternatively or additionally, if the mobile device 1 is not located in the hallway when it receives visible light signals from lighting device 31, the software application may decide that it is not certain that lighting device 31 needs to be commissioned to the hallway room/group in the lighting system and may ask the user to specify a room/group manually or to restart the commissioning process for lighting device 31 after moving the sensor device 11 and/or the mobile device 1 to a different location.

Steps 61-83 may be repeated for other commissionable lighting devices. If the user can only activate the light pattern transmission mode by toggling the lighting device on/off a few times, all lighting devices connected to the same light switch will enter the light pattern transmission mode at the same time if they are independent. In this case, the user 19 may be asked to move the sensor device 11 closer to the lighting device that the user wants to commission. If the lighting devices form a group, e.g. a multi-source luminaire, only one of the lighting devices may enter the light pattern transmission mode and transmit visible light signals for the entire group. Lighting devices that are not connected to the same light switch can be added one after the other.

In the embodiment of the mobile device 1 shown in FIG. 1, the mobile device 1 comprises one processor 5. In an alternative embodiment, the mobile device 1 comprises multiple processors. The processor 5 of the mobile device 1 may be a general-purpose processor, e.g., from ARM or Qualcomm or an application-specific processor. The processor 5 of the mobile device 1 may run an Android or iOS operating system for example. The display 9 may comprise an LCD or OLED display panel, for example. The processor 5 may use touch screen display 9 to provide a user interface, for example. The memory 7 may comprise one or more memory units. The memory 7 may comprise solid state memory, for example.

The RF receiver 3 and the RF transmitter 4 may use one or more wireless communication technologies, e.g., Wi-Fi (IEEE 802.11) for communicating with the wireless LAN access point 17, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The mobile device 1 may comprise other components typical for a mobile device such as a battery and a power connector. The invention may be implemented using a computer program running on one or more processors.

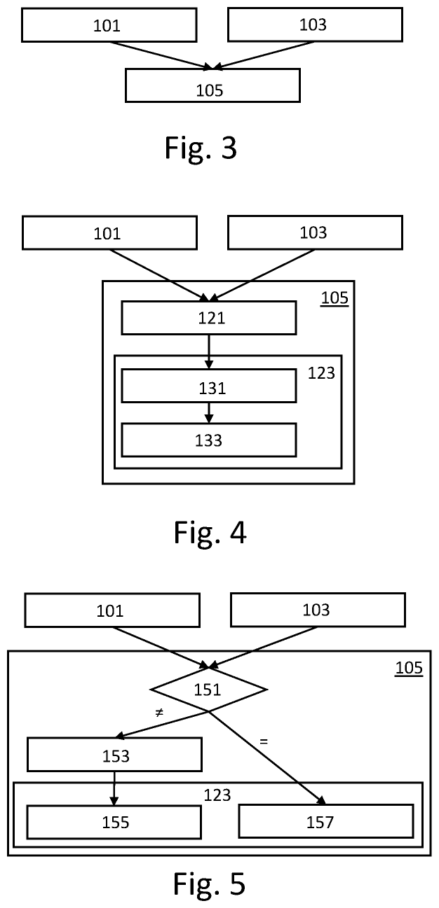

In the embodiment of FIG. 1, a touchscreen display is used by the user to perform the commissioning. In an alternative embodiment, a different kind of interface is used to perform the commissioning, e.g. a display and buttons or a speech interface such as Amazon Alexa or Google Home. In the embodiment of FIG. 1, the (authoritative) system state is stored on the bridge. In an alternative embodiment, the (authoritative) system state is kept on a different device, e.g. on the mobile device or in the cloud. A first embodiment of the method of commissioning a commissionable device into a system is shown in FIG. 3. The method may be performed by the mobile device 1 of FIG. 1, for example. A step 101 comprises receiving, via at least one optical sensor, one or more visible light signals transmitted by the commissionable device. The one or more visible light signals comprises data.

A step 103 comprises receiving one or more radio frequency signals via at least one radio frequency receiver. The one or more radio frequency signals comprise further data. The further data has been determined based on the one or more visible light signals transmitted by the commissionable device as received by at least one further optical sensor of a sensor device. The sensor device and the mobile device are different devices. Steps 101 and 103 may be performed in parallel or in sequence.

A step 105 is performed after steps 101 and 103 have been performed. Step 105 comprises performing a process of commissioning the commissionable device into the system based on the data obtained in step 101 and the further data obtained in step 103. Steps 101-105 may be repeated for other commissionable devices.

A second embodiment of the method of commissioning a commissionable device into a system is shown in FIG. 4. The method may be performed by the mobile device 1 of FIG. 1, for example. Step 101 comprises receiving, via at least one optical sensor, one or more visible light signals transmitted by the commissionable device. The one or more visible light signals comprises data. In the embodiment of FIG. 4, the data obtained in step 101 are indicative of a status of the process of commissioning the commissionable device according to the commissionable device.

Step 103 comprises receiving one or more radio frequency signals via at least one radio frequency receiver. The one or more radio frequency signals comprise further data. The further data has been determined based on the one or more visible light signals transmitted by the commissionable device as received by at least one further optical sensor of a sensor device. The sensor device and the mobile device are different devices.

Step 105 comprises performing a process of commissioning the commissionable device into the system based on the data obtained in step 101 and the further data obtained in step 103. In the embodiment of FIG. 4, step 105 is implemented by a step 121 and a step 123.

Step 121 comprises determining instructions based on the status obtained in step 101. Step 123 comprises providing a user interface to guide a user in the process of commissioning the commissionable device into the system based on the data obtained in step 101. In the embodiment of FIG. 4, step 123 comprises steps 131 and 133. Step 131 comprises informing the user of the status obtained in step 101.

Step 133 comprises providing the instructions determined in step 121 to the user via the user interface. For example, if the user should have put the commissionable device in a light pattern transmission mode, but the status indicates otherwise, the instructions could instruct the user how to put the commissionable device in the light pattern transmission mode.

A spatial location of the sensor device that detected the commissionable device is indicated in the further data and this spatial location is suggested as spatial location for the commissionable device in step 105. If the user confirms this spatial location, the commissionable device is commissioned with this spatial location in the system in step 105.

A third embodiment of the method of commissioning a commissionable device into a system is shown in FIG. 5. The method may be performed by the mobile device 1 of FIG. 1, for example. Step 101 comprises receiving, via at least one optical sensor, one or more visible light signals transmitted by the commissionable device. The one or more visible light signals comprises data. In the embodiment of FIG. 5, the data obtained in step 101 are indicative of a status of the process of commissioning the commissionable device according to the commissionable device.

Step 103 comprises receiving one or more radio frequency signals via at least one radio frequency receiver. The one or more radio frequency signals comprise further data. The further data have been determined based on the one or more visible light signals transmitted by the commissionable device as received by at least one further optical sensor of a sensor device. The sensor device and the mobile device are different devices. In the embodiment of FIG. 5, the further data are indicative of a further status of the process of commissioning the commissionable device according to a controller of the system.

Step 105 comprises performing a process of commissioning the commissionable device into the system based on the data obtained in step 101 and the further data obtained in step 103. In the embodiment of FIG. 5, step 105 is implemented by steps 151-159. Step 151 comprises determining whether a difference exists between the status obtained in step 101 and the further status obtained in step 103. For example, a lamp might indicate that it is not receiving a key to join the (e.g. Zigbee) network while the bridge indicates that this key has been sent. Step 153 is performed if it is determined in step 151 that such a difference exists. Step 157 is performed if it is determined in step 151 that no such difference exists.

Step 153 comprises determining instructions based on the difference determined in step 151. For example, the instructions might provide one or more solutions that the user could try to solve the problem of the lamp not receiving the network key. Next, step 155 comprises informing the user of the difference determined in step 151 and providing the instructions determined in step 153 to the user via a user interface. Step 157 comprises informing the user of the further status obtained in step 103, which is the same as the status obtained in step 101 if step 157 is performed. Steps 155 and 157 implement step 123, which comprises providing a user interface to guide a user in the process of commissioning the commissionable device into the system based on the data obtained in step 101.

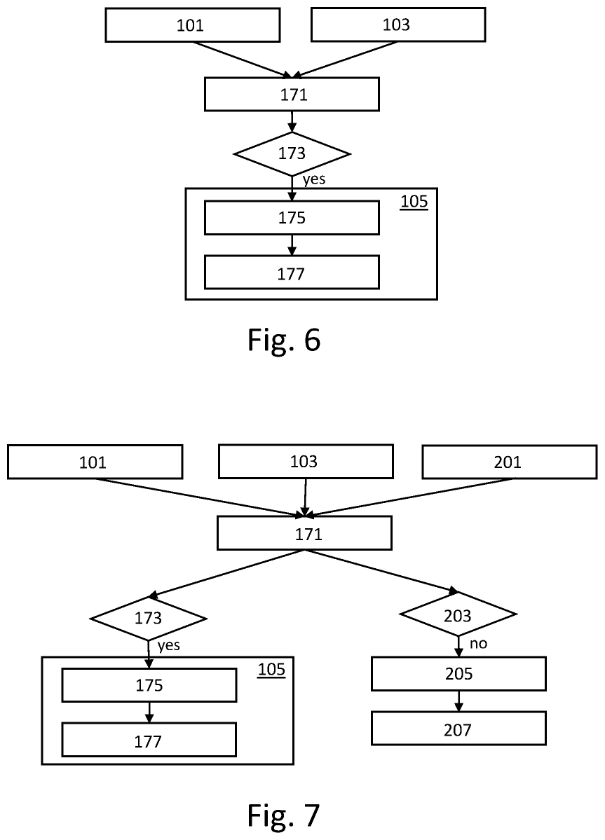

A fourth embodiment of the method of commissioning a commissionable device into a system is shown in FIG. 6. The method may be performed by the mobile device 1 of FIG. 1, for example. Step 101 comprises receiving, via at least one optical sensor, one or more visible light signals transmitted by the commissionable device. The one or more visible light signals comprises data.

A step 103 comprises receiving one or more radio frequency signals via at least one radio frequency receiver. The one or more radio frequency signals comprise further data. The further data has been determined based on the one or more visible light signals transmitted by the commissionable device as received by at least one further optical sensor of a sensor device. The sensor device and the mobile device are different devices. In the embodiment of FIG. 6, the further data are indicative of a first spatial area associated with the sensor device.

A step 171 is performed after steps 101 and 103 have been performed. Step 171 comprises determining a second spatial area in which the mobile device is located. Next, step 173 comprises determining whether the first spatial area and the second spatial area correspond to a same spatial area. If so, a step 175 is performed.

Step 175 comprises determining the spatial area of the commissionable device as the same spatial area to which the first spatial area and the second spatial area correspond. Then, step 177 comprises commissioning the commissionable device into the system with the spatial area determined in step 175.

Thus, in steps 175 and 177, if the first spatial area and the second spatial area determined to correspond to the same spatial area, this same spatial area is associated with the commissionable device as part of the commissioning process. For example, if a sensor device can receive light from devices in multiple groups, e.g. lighting devices in an open kitchen and lighting devices in an adjoining living room, the spatial location of the mobile device may be used to determine the spatial location of the commissionable device more precisely. Steps 175 and 177 are part of step 105.

Optionally, not shown in FIG. 6, if the first and second spatial areas do not correspond to the same spatial area, the user may be offered the possibility to restart the transmission and detection of the visible light signals, e.g. after changing the position of the mobile device and/or the sensor device, and/or may be offered the possibility to manually indicate a spatial area.

A fifth embodiment of the method of commissioning a commissionable device into a system is shown in FIG. 7. The fifth embodiment of FIG. 7 is an extension of the fourth embodiment of FIG. 6. In the embodiment of FIG. 7, a step 203 is performed after step 171. A step 201 is performed before step 203. In the embodiment of FIG. 7, step 201 is performed before step 171 is performed. In an alternative embodiment, step 201 is performed in parallel with step 171 or after step 171.

Step 201 comprises receiving, via the at least one optical sensor, one or more further visible light signals transmitted by a second commissionable device. The one or more further visible light signals comprise second data. Step 203 comprises determining whether the further data obtained in step 103 are based on the one or more further visible light signals transmitted by the second commissionable device, as received in step 201. If not, then step 205 is performed. This likely means that the second commissionable device is not located near the sensor device.

Step 205 comprises determining a further spatial area of the second commissionable device based on the second spatial area determined in step 171. For example, the determined further spatial area of the second commissionable device may be equal to the second spatial area (of the mobile device). Next, step 207 comprises performing a process of commissioning the second commissionable device into the system with the further spatial area determined in step 205.

Thus, if there is not a sensor device in each room, an indication that no sensor device received the visible light signals from a commissionable device may still be used beneficially. In this case, the spatial location of the mobile device may be used as spatial location of this commissionable device.

The embodiments of FIGS. 4 to 7 differ from each other in multiple aspects, i.e., multiple steps have been added or replaced. In variations on these embodiments, only a subset of these steps is added or replaced and/or one or more steps is omitted. For example, steps 121 and 133 may be omitted from the embodiment of FIG. 4 and/or added to the embodiment of FIG. 5. The embodiments of FIGS. 4 and 5 may be combined.

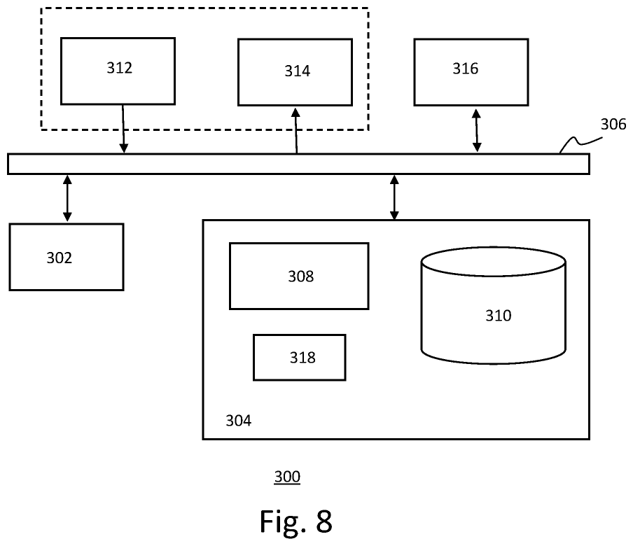

FIG. 8 depicts a block diagram illustrating an exemplary data processing system that may perform the method as described with reference to FIGS. 4 to 7.

As shown in FIG. 8, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification. The data processing system may be an Internet/cloud server, for example.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g., if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g., for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 8 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g., a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 8, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 8) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method of commissioning a commissionable device into a system, said method comprising:
transmitting, by said commissionable device, one or more visible light signals, said one or more visible light signals comprising data;
receiving, via at least one optical sensor of a mobile device, said one or more visible light signals transmitted by said commissionable device;
receiving, by at least one further optical sensor of a sensor device, said one or more visible light signals transmitted by said commissionable device, said sensor device and said mobile device being different devices;
receiving, via at least one radio frequency receiver of the mobile device, one or more radio frequency signals, said one or more radio frequency signals comprising further data, said further data being determined based on said one or more visible light signals transmitted by said commissionable device as received by said at least one further optical sensor of said sensor device; and
performing a process of commissioning said commissionable device into said system based on said data and said further data.

2. The method as claimed in claim 1, wherein said method further comprises:
providing, by the mobile device, a user interface to guide a user in said process of commissioning said commissionable device into said system based on said data.

3. The method as claimed in claim 2, wherein said data are indicative of a status of said process of commissioning said commissionable device according to said commissionable device.

4. The method as claimed in claim 3, wherein said method further comprises:
informing said user of said status via said user interface.

5. The method as claimed in claim 4, wherein said method further comprises:
determining instructions, by the mobile device, based on said status; and
providing said instructions to said user via said user interface.

6. The method as claimed in claim 3, wherein said further data are indicative of a further status of said process of commissioning said commissionable device according to a controller of said system and wherein said method further comprises:
determining, by the mobile device, whether a difference exists between said status and said further status, and
informing, via said user interface, said user of said difference if said difference is determined to exist.

7. The method as claimed in claim 6, wherein said method further comprises:
determining, by the mobile device, instructions based on said difference and provide said instructions to said user via said user interface.

8. The method as claimed in claim 6, wherein said method further comprises:
informing, by the mobile device, said user, via said user interface, of said further status if no difference is determined to exist between said status and said further status.

9. The method as claimed in claim 1, wherein said further data are indicative of a first spatial area associated with said sensor device and wherein said method further comprises:
determining, by the mobile device, a second spatial area in which said mobile device is located,
determining, by the mobile device, a spatial area of said commissionable device based on said first and second spatial areas, and wherein the step of performing a process of commissioning said commissionable device into said system comprises commissioning said commissionable device into said system with said spatial area.

10. The method as claimed in claim 9, wherein said method further comprises:
determining, by the mobile device, whether said first spatial area and said second spatial area correspond to a same spatial area, and
associating, by the mobile device, said same spatial area with said commissionable device as part of said commissioning process if said first spatial area and said second spatial area determined to correspond to said same spatial area.

11. The method as claimed in claim 10, wherein said method further comprises:
receiving, via said at least one optical sensor, one or more further visible light signals transmitted by a second commissionable device, said one or more further visible light signals comprising second data,
determining, by the mobile device, whether said further data are based on said one or more further visible light signals transmitted by said second commissionable device,
determining, by said mobile device, a further spatial area of said second commissionable device based on said second spatial area if said further data are not based on said one or more further visible light signals transmitted by said second commissionable device, and
performing a process of commissioning said second commissionable device into said system based on said second data.

12. The method as claimed in claim 1, wherein said commissionable device is a lighting device and said system is a lighting system.

13. A system comprising a mobile device for commissioning a commissionable device into a system, said mobile device comprising:
at least one optical sensor;
at least one radio frequency receiver; and
at least one processor configured to:
receive, via said at least one optical sensor, one or more visible light signals transmitted by said commissionable device, said one or more visible light signals comprising data,
receive one or more radio frequency signals via said at least one radio frequency receiver, said one or more radio frequency signals comprising further data, said further data being determined based on said one or more visible light signals transmitted by said commissionable device as received by at least one further optical sensor of a sensor device, said sensor device and said mobile device being different devices, and
perform a process of commissioning said commissionable device into said system based on said data and said further data,
said lighting system further comprising said sensor device and said commissionable device.

14. A computer program product for commissioning a commissionable device into a system, the computer program product comprising computer program code arranged for performing the steps of:
transmitting, by a commissionable device, one or more visible light signals, said one or more visible light signals comprising data;
receiving, via at least one optical sensor of a mobile device, said one or more visible light signals transmitted by said commissionable device;
receiving, by at least one further optical sensor of a sensor device, said one or more visible light signals transmitted by said commissionable device, said sensor device and said mobile device being different devices;
receiving, via at least one radio frequency receiver of the mobile device, one or more radio frequency signals, said one or more radio frequency signals comprising further data, said further data being determined based on said one or more visible light signals transmitted by said commissionable device as received by said at least one further optical sensor of said sensor device; and
performing a process of commissioning said commissionable device into said system based on said data and said further data.
